(19) United States
(12) Patent Application Publication
(10) Pub. No.: US 2004/0093280 A1
(43) Pub. Date: May 13, 2004

(54) System for hiring taxi, handy terminal for doing the same, and method of doing the same

(75) Inventor: Yuich Yamaguchi, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/701,016

(22) Filed: Nov. 5, 2003

(30) Foreign Application Priority Data
Nov. 6, 2002 (JP) 202-321935

(51) Int. Cl. G06F 17/60

(52) U.S. Cl. 705/26

(57) ABSTRACT

A system for hiring a taxi is comprised of a handy terminal, a receiver equipped in a taxi, and a calculator. The handy terminal has functions of detecting a current position of itself through GPS (Global Positioning System), and transmitting a request to the receiver of a taxi located in the vicinity of the handy terminal that the taxi comes to the handy terminal. The calculator calculates an arrival time at which the taxi is expected to arrive at the handy terminal, based on the current position of the handy terminal and a current position of the taxi.

### BACKGROUND OF THE INVENTION

1. Field of the Invention

The invention relates to system for hiring a taxi, a handy terminal used in such a system, a method of hiring a taxi, and a program for causing a computer to carry out a method of hiring a taxi.

2. Description of the Related Art

For instance, Japanese Patent Application Publication No. 2002-157689 has suggested a method of calculating an arrival time at which a taxi arrives at a place a user indicated. In the method, an arrival time at which a taxi arrives at a place a user indicated is calculated by a data processor equipped in a taxi company, based on data indicative of a current position of a user, input by a user himself/herself to the data processor through his/her handy terminal, and data indicative of a location of a taxi including a radio-transceiver by which a current position of the taxi can be detected through GPS (Global Positioning System).

However, the method is accompanied with a problem that an arrival time at which a taxi arrives at a place a user indicated cannot be calculated at real-time unless a user inputs data indicative of a his/her current position into the data processor through his/her terminal.

The method is accompanied further with a problem that the method cannot provide a taxi user with various taxi information a taxi user would like to know.

Japanese Patent Application Publication No. 2002-42298 has suggested a method of hiring a taxi. In the method, a user transmits data indicative of his/her destination and services he/she would like to have, to a server through his/her terminal. The server retrieves a taxi, based on the received data, and selects a taxi matching to the user's requirements. The server transmits retrieval results to both the user's terminal and a terminal of the selected taxi.

Japanese Patent Application Publication No. 2002-63690 has suggested a method of directing a taxi to a user, including the steps of receiving data including a current position of a user, transmitting the received data to a plurality of servers, receiving taxi information as a response, making a list of available taxis based on the received taxi information, and transmitting the list to a user.

Japanese Patent Application Publication No. 2002-74119 has suggested a taxi-reservation system in which when a user calls a taxi, a server transmits to the user information relating to a taxi fare.

Japanese Patent Application Publication No. 2002-222492 has suggested a system for optimally directing taxis, including terminals of users, a network, taxis each having a device which receives signals from and transmits signals to a GPS satellite, a taxi-data processor transmitting a list of available taxis, and a taxi retriever retrieving a taxi, based on taxi information such as a current position of a taxi.

Japanese Patent Application Publication No. 2002-251433 has suggested a system of hiring a taxi, in which a user having a terminal device having a function of detecting its current position transmits a request to hire a taxi to a taxi company.

Japanese Patent Application Publication No. 2002-149527 has suggested a system in which a provider allows a user to make access to a web site which provides data indicative of a current position of taxis to users of handy terminals.

Japanese Patent Application Publication No. 2002-222245 has suggested a system of providing taxi information, in which a user transmits data indicative of his/her current position to a host computer through his/her terminal device, and a taxi transmits data indicative of its current position to the host computer. The host computer transmits information relating to available taxis to the user.

Japanese Patent Application Publication No. 2002-259518 has suggested a system of hiring a taxi, in which a user makes access to a host computer of a taxi company through Internet to know taxi fare information, an arrival time at which a taxi arrives at the user, and a time necessary for arriving at a user's destination.

Japanese Patent Application Publication No. 2002-279589 has suggested a system of hiring a taxi, in which a taxi which is closest to a user comes to the user, and the user can know an arrival time at which the taxi arrives.

Japanese Patent Application Publication No. 2002-279587 has suggested a system of hiring a taxi, in which a user transmits his/her current position to a host computer through his/her terminal, and taxis periodically transmit their current positions to the host computer. The host computer compares current positions of a user and taxis, finds a taxi closest to the user, and transmits an instruction to the taxi to move to the user.

Japanese Patent Application Publication No. 2002-133588 has suggested a system of hiring a taxi, in which a user transmits his/her current position and his/her requirements such as a minimum fare to a server through his/her terminal. The server finds taxis meeting with the user's requirements, and transmits a list of the taxis to the user. The user selects one of the taxis in the list. On receipt of the user's selection, the server transmits an instruction to the selected taxi to move to the user.

Japanese Patent Application Publication No. 2002-183874 has suggested a system of hiring a taxi, in which a taxi detects its current position through GPS system, and transmits the current position to a network. Similarly, a user detects his/her current position through his/her terminal through GPS system, and transmits a request of hiring a taxi to the network together with his/her current position. On receipt of the request of a user, the taxi transmits its current position to a user. On receipt of the current position of the taxi, a user determines whether he/she selects the taxi. If the user selects the taxi, he/she transmits his/her determination to the taxi.

### SUMMARY OF THE INVENTION

In view of the above-mentioned problems in the conventional systems and methods, it is an object of the present invention to provide a system for hiring a taxi, a handy terminal used in the system, a method of hiring a taxi, and a program for causing a computer to carry out a method of hiring a taxi, all of which are capable of enabling a taxi user to know an arrival time at which a taxi is expected to arrive at a place a taxi user indicated or a current position of a taxi user, without necessity of a taxi user to input his/her current position into his/her handy terminal.

It is also an object of the present invention to provide a system for hiring a taxi, a handy terminal used in the system, a method of hiring a taxi, and a program for causing a computer to carry out a method of hiring a taxi, all of which are capable of readily providing a taxi user with various taxi information which a taxi user would like to know.

In one aspect of the present invention, there is provided a system for hiring a taxi, including a handy terminal, a receiver equipped in a taxi, and a calculator, the handy terminal having functions of detecting a current position of itself through GPS (Global Positioning System), and transmitting a request to the receiver of a taxi located in the vicinity of the handy terminal that the taxi comes to the handy terminal, the calculator calculating an arrival time at which the taxi is expected to arrive at the handy terminal, based on the current position of the handy terminal and a current position of the taxi.

The calculator may be equipped in the handy terminal.

The system may further include a taxi-data server storing therein data relating to the taxi, in which case, the handy terminal has a function of displaying the taxi data transmitted from the taxi-data server.

It is preferable that the taxi data includes at least one of a current position of the taxi, a fare of the taxi, an age of a driver of the taxi, years for which a driver of the taxi continues service, comments of the driver, and comments of a user who previously took the taxi.

It is preferable that the handy terminal displays a plurality of the taxi data therein such that a user of the handy terminal can select a taxi among displayed taxis, based on the plurality of the taxi data.

It is preferable that the handy terminal downloads the taxi data from the taxi-data server thereto through a packet network, a packet network gateway and Internet.

It is preferable that the handy terminal downloads the taxi data from the taxi-data server thereto through a cellular phone network, an access point of an Internet service provider (ISP) and Internet.

The system may further include a memory storing data of taxis which users used to hire, and wherein the calculator receives a current position of a taxi which a user of the handy terminal selects among the taxis, from the taxi-data server, and calculates an arrival time at which the selected taxi is expected to arrive at the handy terminal, based on a current position of the handy terminal and the current position of the taxi.

It is preferable that the handy terminal receives, after transmission of the request to the receiver, at least one of a current position of the handy terminal and a current position of the taxi at real-time.

It is preferable that the taxi-data server receives comments of a user of the handy terminal about a taxi which the user hired, through Internet.

It is preferable that the handy terminal includes a transmitter transmitting data of a destination to the receiver when the handy terminal transmits the request to the receiver.

It is preferable that the handy terminal includes a memory storing therein data of a route which a taxi a user of the handy terminal hired ran.

For instance, the handy terminal may be comprised of a cellular phone.

The system may further include a map-data server storing therein data about a map of an area covering from a current position of the taxi to a current position of the handy terminal, and data about speed restriction of roads in the area, in which case, the handy terminal receives the data from the map-data server.

In another aspect of the present invention, there is provided a handy terminal used in a system for hiring a taxi, the system being comprised of the handy terminal and a receiver equipped in a taxi, the handy terminal having functions of detecting a current position of itself through GPS (Global Positioning System), and transmitting a request to the receiver equipped in a taxi located in the vicinity of the handy terminal that the taxi comes to the handy terminal, the handy terminal including a calculator calculating an arrival time at which the taxi is expected to arrive at the handy terminal, based on the current position of the handy terminal and a current position of the taxi.

If the system further includes a taxi-data server storing therein data relating to the taxi, the handy terminal preferably has a function of displaying the taxi data transmitted from the taxi-data server.

It is preferable that the handy terminal displays a plurality of the taxi data such that a user of the handy terminal can select a taxi among displayed taxis, based on the plurality of the taxi data.

It is preferable that the handy terminal downloads the taxi data from the taxi-data server thereto through a packet network, a packet network gateway and Internet.

It is preferable that the handy terminal downloads the taxi data from the taxi-data server thereto through a cellular phone network, an access point of an Internet service provider (ISP) and Internet.

The handy terminal may further include a memory storing data of taxis which other users used to hire, in which case, the calculator receives a current position of a taxi which a user of the handy terminal selects among the taxis, from the taxi-data server, and calculates an arrival time at which the selected taxi is expected to arrive at the handy terminal, based on a current position of the handy terminal and the current position of the taxi.

It is preferable that the handy terminal receives, after transmission of the request to the receiver, at least one of a current position of the handy terminal and a current position of the taxi at real-time.

The handy terminal may further include a transmitter transmitting data of a destination to the receiver when the handy terminal transmits the request to the receiver.

The handy terminal may further include a memory storing therein data of a route which a taxi a user of the handy terminal hired ran.

For instance, the handy terminal may be comprised of a cellular phone.

In still another aspect of the present invention, there is provided a method of hiring a taxi by transmitting a request from a user's handy terminal to a receiver equipped in a taxi located in the vicinity of the handy terminal that the taxi comes to the handy terminal, including (a) detecting a current position of the handy terminal through GPS (Global Positioning System), and (b) calculating an arrival time at which the taxi is expected to arrive at the handy terminal, based on the current position of the handy terminal and a current position of the taxi.

The method may further including (c) receiving data relating to the taxi from a taxi-data server, and (d) displaying the taxi data in the handy terminal.

It is preferable that the handy terminal displays a plurality of the taxi data in the (d) such that a user of the handy terminal can select a taxi among displayed taxis, based on the plurality of the taxi data.

The method may further include downloading the taxi data from the taxi-data server to the handy terminal through a packet network, a packet network gateway and Internet.

The method may further include downloading the taxi data from the taxi-data server to the handy terminal through a cellular phone network, an access point of an Internet service provider (ISP) and Internet.

The method may further include storing data of taxis which users used to hire, and receiving a current position of a taxi which a user of the handy terminal selects among the taxis, from the taxi-data server.

The method may further include transmitting comments of a user of the handy terminal about a taxi which the user hired, to the taxi-data server through Internet.

The method may further include transmitting data of a destination to the receiver when the handy terminal transmits the request to the receiver.

The method may further include storing therein data of a route which a taxi a user of the handy terminal hired ran.

In yet another aspect of the present invention, there is provided a program for causing a computer to carry out a method of hiring a taxi by transmitting a request from a user's handy terminal to a receiver equipped in a taxi located in the vicinity of the handy terminal that the taxi comes to the handy terminal, and wherein steps executed by the computer in accordance with the program include (a) detecting a current position of the handy terminal through GPS (Global Positioning System), and (b) calculating an arrival time at which the taxi is expected to arrive at the handy terminal, based on the current position of the handy terminal and a current position of the taxi.

The steps may further include (c) receiving data relating to the taxi from a taxi-data server, and (d) displaying the taxi data in the handy terminal.

It is preferable that a plurality of the taxi data is displayed in the (d) such that a user of the handy terminal can select a taxi among displayed taxis, based on the plurality of the taxi data.

The steps may further include downloading the taxi data from the taxi-data server to the handy terminal through a packet network, a packet network gateway and Internet.

The steps may further include downloading the taxi data from the taxi-data server to the handy terminal through a cellular phone network, an access point of an Internet service provider (ISP) and Internet.

The steps may further include storing data of taxis which users used to hire, and receiving a current position of a taxi which a user of the handy terminal selects among the taxis, from the taxi-data server.

The steps may further include transmitting comments of a user of the handy terminal about a taxi which the user hired, to the taxi-data server through Internet.

The steps may further include transmitting data of a destination to the receiver when the handy terminal transmits the request to the receiver.

The steps may further include storing therein data of a route which a taxi a user of the handy terminal hired ran.

The advantages obtained by the aforementioned present invention will be described hereinbelow.

In accordance with the present invention, when a user having a handy terminal which is capable of detecting its current position through GPS (Global Positioning System) would like to take a taxi, the calculator, which may be equipped in the handy terminal, calculates an arrival time at which taxis running in the vicinity of the user's current position arrive at the user. The calculated time is displayed in the handy terminal. Hence, the user can select a taxi which can arrive at the user at the earliest time.

In accordance with the present invention, a user can know various taxi information as well as an arrival time at which a taxi arrives at the user. Specifically, a user can receive data indicative of fare information including initial fare, taxi driver data such as an age of a taxi driver, years in which a taxi driver continues service, and comments of a taxi driver, and a name of taxi company.

In accordance with the present invention, data indicative of a current position of a user is obtained by his/her handy terminal having GPS function, data indicative of taxis running in the vicinity of the user is obtained from the taxi-data server, and data of a map around the user is obtained from a map-data server, for instance. Based on these data, a distance between a user and a taxi and an arrival time at which the taxi arrives at the user are calculated by the calculator. In addition, a fare, gender of a taxi driver, an age of a taxi driver, years in which a taxi driver continues service, and comments of a taxi driver are displayed in a display screen of the user's handy terminal. Thus, a user can know an arrival time at which a taxi arrives at and various information of a plurality of taxis without transmitting his/her current position into a taxi company unlike the conventional method. Hence, a user can select a most desirable taxi among taxis running around the user.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a system in accordance with the first embodiment of the present invention.

FIG. 2 is a block diagram of a handy terminal used in the system in accordance with the first embodiment of the present invention.

FIG. 3 illustrates a relation between the handy terminal illustrated in FIG. 2 and a network in the first embodiment.

FIG. 4 illustrates an example of database of a taxi-data server constituting the system in accordance with the first embodiment.

FIG. 5 illustrates an example of what is displayed in the handy terminal illustrated in FIG. 2.

FIG. 6 is a flow-chart of an operation of the system in accordance with the first embodiment of the present invention.

FIG. 7 is a block diagram of a system in accordance with the second embodiment of the present invention.

FIG. 8 is a flow-chart of an operation of the system in accordance with the second embodiment of the present invention.

FIG. 9 illustrates a relation between a handy terminal and a network in the third embodiment.

FIG. 10 is a block diagram of a handy terminal used in the system in accordance with the fourth embodiment of the present invention.

FIG. 11 is a flow-chart of an operation of the system in accordance with the fifth embodiment of the present invention.

FIG. 12 is a flow-chart of an operation of the system in accordance with the sixth embodiment of the present invention.

FIG. 13 illustrates an example of database of a taxi-data server constituting the system in accordance with the seventh embodiment.

FIG. 14 is a block diagram of a handy terminal used in the system in accordance with the eighth embodiment of the present invention.

FIG. 15 is a flow-chart of an operation of the system in accordance with the eighth embodiment of the present invention.

FIG. 16 is a block diagram of a handy terminal used in the system in accordance with the ninth embodiment of the present invention.

### DESCRIPTION OF THE PREFERRED EMBODIMENTS

Preferred embodiments in accordance with the present invention will be explained hereinbelow with reference to drawings.

[First Embodiment]

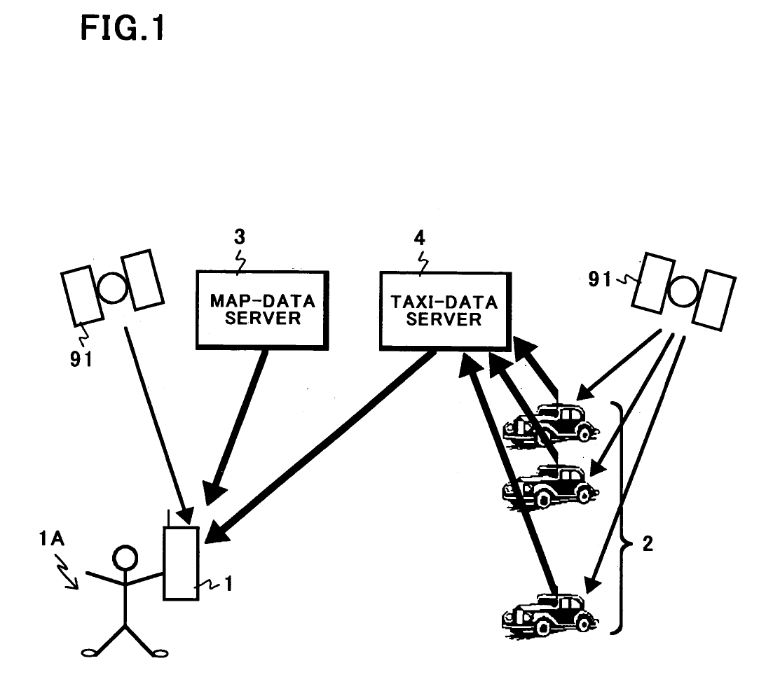

FIG. 1 is a block diagram of a system for hiring a taxi, in accordance with the first embodiment of the present invention.

As illustrated in FIG. 1, the system in accordance with the first embodiment is comprised of a handy terminal 1 of a user 1A, a map-data server 3, and a taxi-data server 4.

The handy terminal 1 is designed to have a function of detecting a current position of the user 1A through GPS (Global Positioning System). Specifically, the handy terminal 1 receives a signal transmitted from a GPS satellite 91 to identify a current position of the user 1A. The handy terminal 1 is comprised of a cellular phone or a personal digital assistant (PDA), for instance.

A plurality of taxis 2 runs in the vicinity of the user 1A. Each of the taxis 2 has a GPS terminal and a radio-signal transceiver. Each of the taxis 2 receives a signal from the GPS satellite 91 through the GPS terminal to identify a current position thereof, and, on receipt of a request from the user 1A to catch the user 1A, transmits a message to the user 1A through the radio-signal transceiver.

The map-data server 3 stores therein data about a map of an area covering from a current position of each of the taxis 2 to a current position of the user 1A, and data about speed restriction of roads in the area.

The taxi-data server 4 stores therein a current position of each of the taxis 2, fare information such as initial fare, driver information such as an age of a taxi driver, years in which a taxi driver continues service, and comments of a taxi driver, and names of taxi companies.

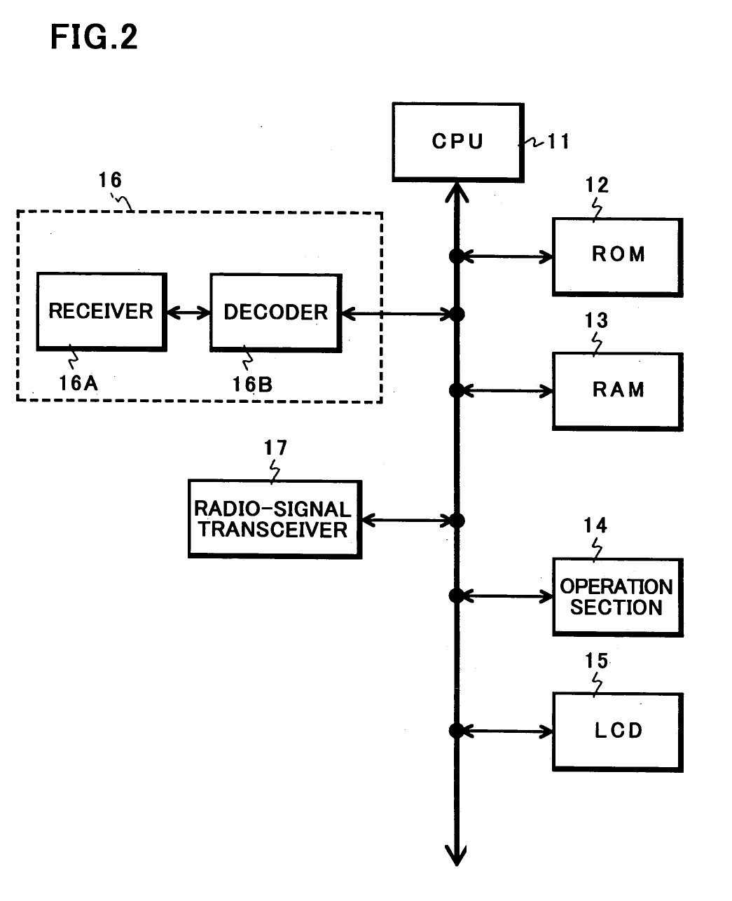

FIG. 2 is a block diagram of the handy terminal 1.

As illustrated in FIG. 2, the handy terminal 1 is comprised of a central processing unit (CPU) 11, a read only memory (ROM) 12, a random access memory (RAM) 13, an operation section 14 including a plurality of keys, a liquid crystal display (LCD) 15, a data processor 16, and a radio-signal transceiver 17.

The central processing unit 11 carries out various calculation and calculates an arrival time at which a taxi is expected to arrive at the user 1A.

The read only memory 12 stores therein a program for controlling an operation of the central processing unit 11. The random access memory 13 provides a working area for the central processing unit 11.

The user 1A can input data into the handy terminal 1 through the operation section 14. For instance, the user 1A can select a taxi among a plurality of taxis by actuating a predetermined key among a plurality of keys arranged in the operation section 14.

The liquid crystal display 15 displays an arrival time at which each of the taxis 2 arrives at the user 1A, a fare, information of taxi drivers of the taxis 2, and names of taxi companies to which the taxi drivers belong.

The data processor 16 is comprised of a radio-signal receiver 16A including an antenna (not illustrated) through which signals transmitted from the GPS satellite 91 are received, and a decoder 16B which converts the signals received through the radio-signal receiver 16A, into data indicative of a current position of the handy terminal 1. That is, the data processor 16 receives signals from the GPS satellite 91, and identifies a current position of the hand terminal 1, based on the received signals.

The handy terminal 1 makes access to the map-data server 3 and the taxi-data server 4 through the radio-signal transceiver 17, and downloads data from the servers 3 and 4 through the radio-signal transceiver 17. In addition, the handy terminal 1 transmits messages to and receives messages from the servers 3 and 4 through the radio-signal transceiver 17.

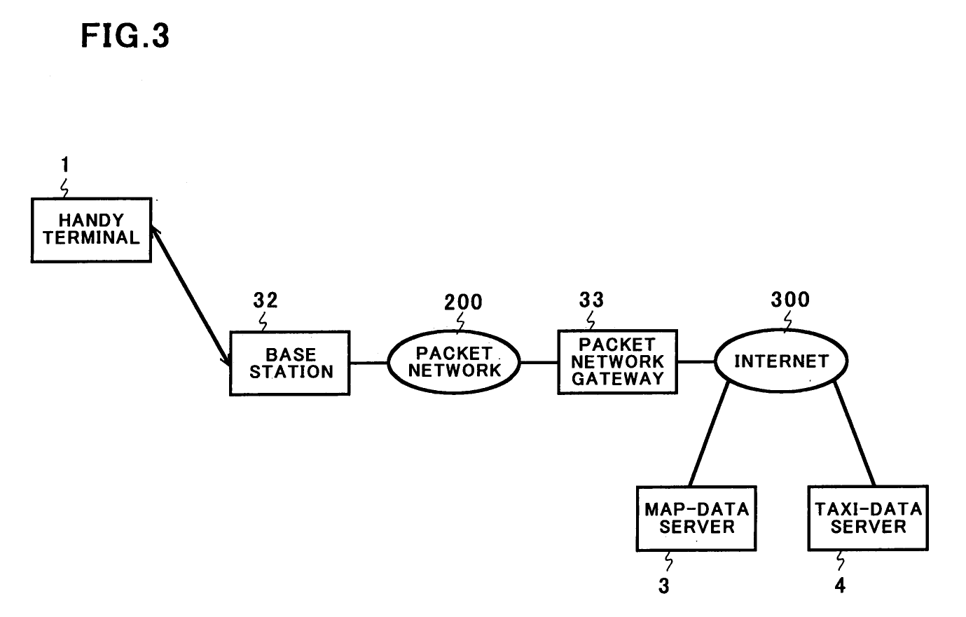

FIG. 3 shows a network between the handy terminal 1 and the servers 3 and 4.

As illustrated in FIG. 3, the handy terminal 1 receives data stored in the servers 3 and 4, through a base station 32, a packet network 200, a packet network gateway 33 and Internet 300.

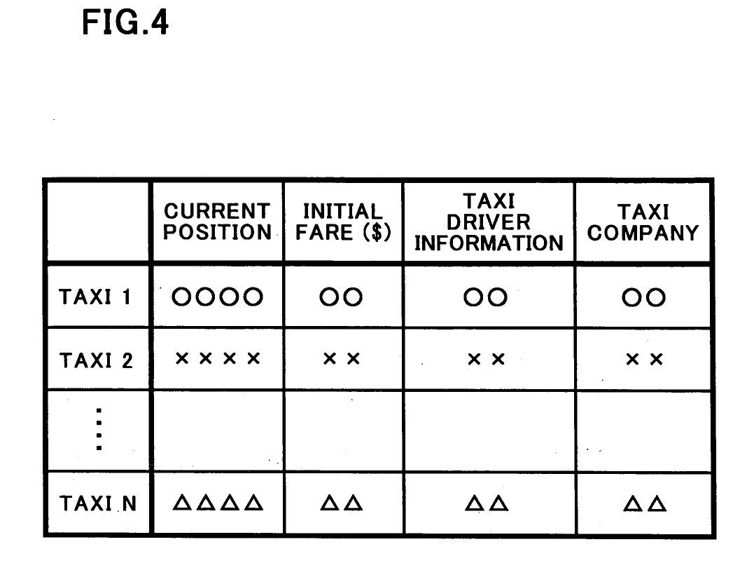

FIG. 4 illustrates an example of database of the taxi-data server 4.

As illustrated in FIG. 4, the taxi-data server 4 has a database storing therein a current position of each of the taxis 2, fare information including an initial fare, taxi driver information including an age of a taxi driver, years in which a taxi driver continues service, and comments of a taxi driver, and names of taxi companies. The taxi-data server 4 always receives information from the taxis 2, and updates the database at real-time.

The map-data server 3 stores map data about an area including both a current position of each of the taxis 2 and a current position of the user 1A, and information about speed restriction of roads in the area.

First, the handy terminal 1 obtains data indicative of a current position thereof by receiving GPS signals from the satellite 91 through the data processor 16. Then, the handy terminal 1 makes access to the taxi-data server 4 and the map-data server 3 through the base station 32, the packet gateway 200, the packet network gateway 33 and the Internet 300 to receive data relating to a current position of each of the taxis 2, a map around a current position of the user 1A and a current position of each of the taxis 2, and speed restriction, through the radio-signal transceiver 17.

Then, the central processing unit 11 executes a control program stored in the read only memory 12 to calculate a distance between a current position of the user 1A and a current position of each of the taxis 2 and an arrival time at which each of the taxis 2 is expected to arrive at the user 1A, based on the received data, and then, display the thus calculated distance and time and the received taxi information in the liquid crystal display 15.

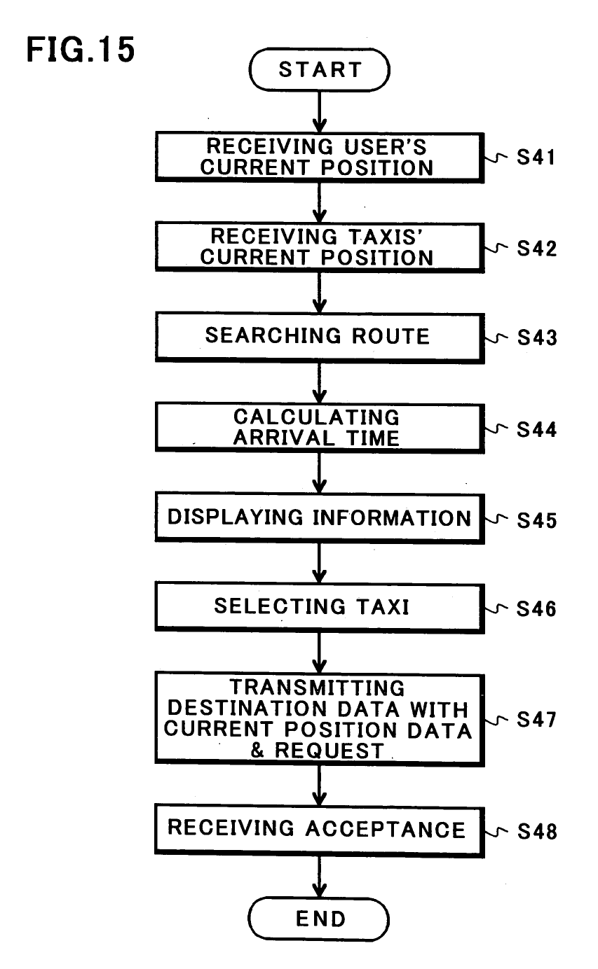

An example of information to be displayed in the liquid crystal display 15 is illustrated in FIG. 15. For instance, an arrival time at which each of the taxis 2 is expected to arrive at the user 1A, an initial fare, taxi driver information, and a taxi company name are displayed in the liquid crystal display 15.

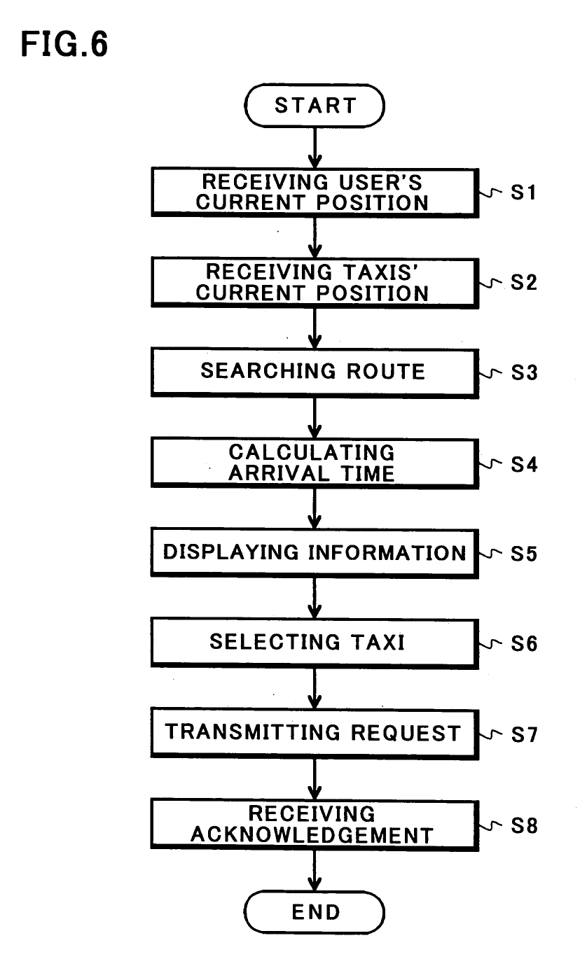

FIG. 6 is a flow-chart of an operation of the system in accordance with the first embodiment.

Hereinbelow is explained an operation of the system with reference to FIG. 6. The central processing unit 11 executes a control program stored in the read only memory 12, to thereby carry out steps shown in FIG. 6.

The central processing unit 11 in the handy terminal 1 receives GPS signals from the satellite 91 through the radio-signal receiver 16A, and decodes the received GPS signals in the decoder 16B to have data indicative of a current position of the user 1A, in step S1.

Then, the central processing unit 11 makes access to the taxi-data server 4 through the radio-signal transceiver 17, and receives taxi-driver information and names of taxi companies as illustrated in FIG. 4, from the taxi-data server 4 through the base station 32, the packet gateway 200, the packet network gateway 33 and the Internet 300, in step S2.

Then, the central processing unit 11 makes access to the map-data server 3 to receive data of a map covering an area between a current position of the user 1A and a current position of each of the taxis 2 and data about speed restriction in the area from the map-data server 3, based on the data received in the above-mentioned steps S1 and S2. Based on the data received from the map-data server 3, the central processing unit 11 searches a route and calculates a distance between a current position of the user 1A and a current position of each of the taxis 2, in step S3.

Then, the central processing unit 11 calculates an arrival time at which each of the taxis 2 is expected to arrive at the user 1A in step S4, based on the distance and the speed restriction both obtained in step S3.

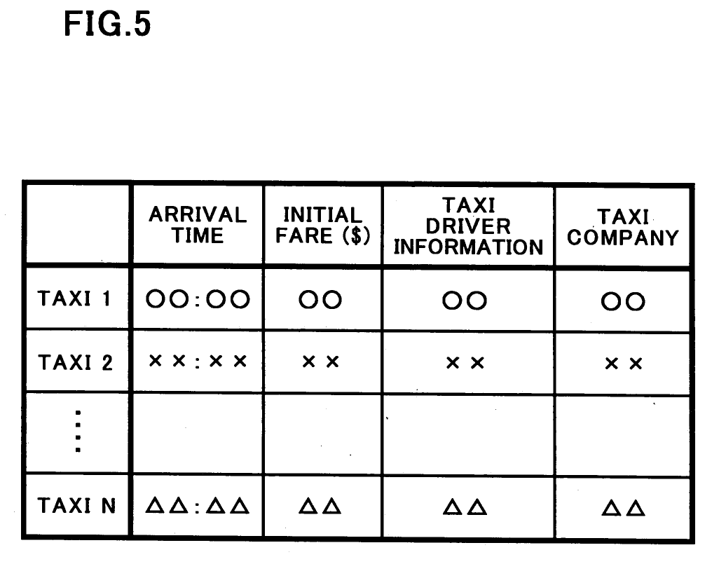

Then, the central processing unit 11 displays the taxi driver information and names of taxi companies both obtained in step S2 and the arrival time calculated in step S4, in the liquid crystal display 15, in step S5. An example of displayed information is illustrated in FIG. 5.

Then, the user 1A selects one of the taxis 2 displayed in the liquid crystal display 15, by actuating a predetermined key, in step S6.

Then, the central processing unit 11 transmits a request to arrive at the user 1A together with data indicating a current position of the user 1A to the selected taxi 2 through the Internet 300, in step S7.

On receipt of the request from the central processing unit 11 of the handy terminal 1, the selected taxi 2 transmits acknowledgement to the handy terminal 1 of the user 1A through the Internet 300. The central processing unit 11 receives the acknowledgement from the selected taxi 2 through the radio-signal transceiver 17, in step S8.

If the user 1A would like to know an arrival time at which a taxi is expected to arrive at the user 1A, the user 1A has to know his/her current position, because a distance between a current position of the user 1A and a current position of a taxi has to be calculated. As explained above, in accordance with the first embodiment, the user 1A can know his/her current position by receiving GPS signals from the GPS satellite 91 without any operation such as actuation of a predetermined key, unlike the conventional system. Based on the thus obtained current position of the user 1A and a current position of a taxi, the central processing unit 11 of the handy terminal 1 calculates an arrival time at which the selected taxi 2 is expected to arrive at the user 1A. Thus, the user 1A can know arrival time of the selected taxi 2 without any specific operation.

In addition, the user 1A can get taxi driver information and a name of a taxi company as well as the arrival time of a taxi.

In accordance with the first embodiment, the user 1A receives taxi driver information of a plurality of taxi drivers. Hence, based on received taxi driver information, the user 1A can select his/her desired taxi among a plurality of taxis.

In the first embodiment, the handy terminal 1 may be designed to store data stored in the map-data server 3.

[Second Embodiment]

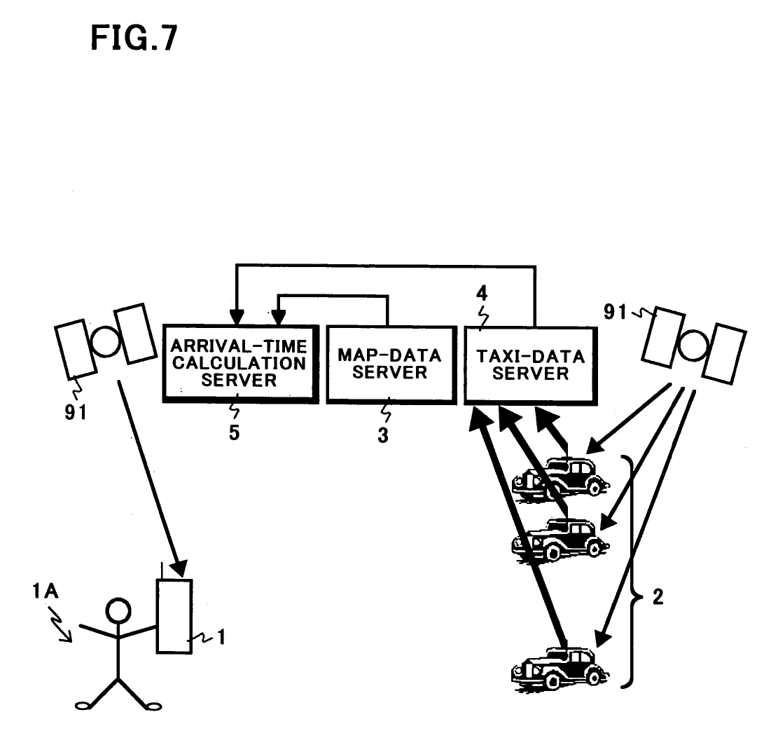

FIG. 7 is a block diagram of a system for hiring a taxi, in accordance with the second embodiment of the present invention.

The system in accordance with the second embodiment is designed to additionally include an arrival-time calculation server 5 in comparison with the system in accordance with the first embodiment. Parts or elements that correspond to those of the first embodiment have been provided with the same reference numeral.

In the second embodiment, an arrival-time at which a taxi 2 is expected to arrive at the user 1A is not calculated in the handy terminal unlike the first embodiment, but calculated in the arrival time calculation server 5 which is separately arranged from the handy terminal 1. Specifically, the arrival-time calculation server 5 receives data indicative of a current position of the user 1A from the handy terminal 1, and calculates an arrival time, based on the received current position of the user 1A and a current position of each of the taxis 2.

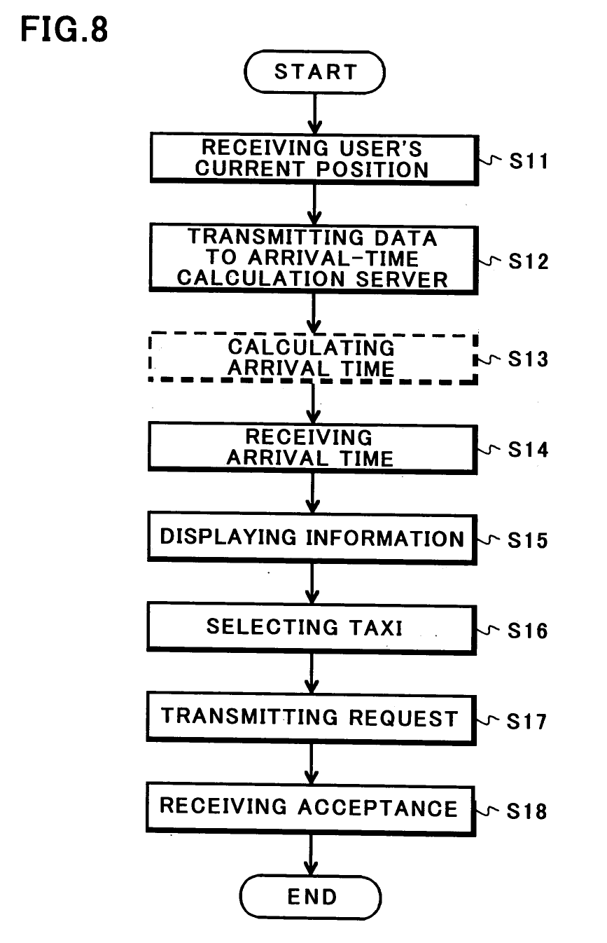

FIG. 8 is a flow-chart of an operation of the system in accordance with the second embodiment.

Hereinbelow is explained an operation of the system in accordance with the second embodiment, with reference to FIGS. 7 and 8. An operation of the handy terminal 1 is explained with reference to FIG. 2, because the handy terminal 1 in the second embodiment has the same structure as that of the handy terminal 1 in the first embodiment.

The central processing unit 11 of the handy terminal 1 receives GPS signals from the GPS satellite 91 through the radio-signal receiver 16A, and decodes the received GPS signals in the decoder 16B. Thus, the central processing unit 11 obtains data indicative of a current position of the user 1A, in step S11. The central processing unit 11 transmits the thus obtained data to the arrival-time calculation server through the radio-signal transceiver 17, in step S12.

On receipt of the data from the central processing unit 11 of the handy terminal 1, the arrival-time calculation server 5 makes access to the taxi-data server 4 to receive data indicative of a current position of each of the taxis 2 and fare information such as an initial fare. Then, the arrival-time calculation server 5 makes access to the map-data server 3 to receive data of a map covering an area between a current position of the user 1A and a current position of each of the taxis 2 and data about speed restriction in the area, from the map-data server 3, based on data indicating a current position of the user 1A and a current position of each of the taxis 2. Then, the arrival-time calculation server 5 searches a route, calculates a distance between a current position of the user 1A and a current position of each of the taxis 2, and further calculates an arrival time, in step S13.

The arrival-time calculation server 5 transmits the thus calculated arrival time and the received taxi fare information, taxi driver information and names of taxi companies to the handy terminal 1, in step S14. On receipt of them, the central processing unit 1 displays the received data in the liquid crystal display 15, in step S15.

Then, the user 1A selects one of taxis displayed in the liquid crystal display 15 by actuating a predetermined key, in step S16.

Then, the central processing unit 11 transmits a request to arrive at the user 1A together with data indicating a current position of the user 1A to the selected taxi 2 through the Internet 300, in step S17.

On receipt of the request from the central processing unit 11 of the handy terminal 1, the selected taxi 2 transmits acknowledgement to the handy terminal 1 of the user 1A through the Internet 300. The central processing unit 11 receives the acknowledgement from the selected taxi 2 through the radio-signal transceiver 17, in step S18.

In accordance with the second embodiment, it is no longer necessary for the central processing unit 11 to calculate an arrival time at which a taxi is expected to arrive at the user 1A, ensuring reduction in burden of data processing.

[Third Embodiment]

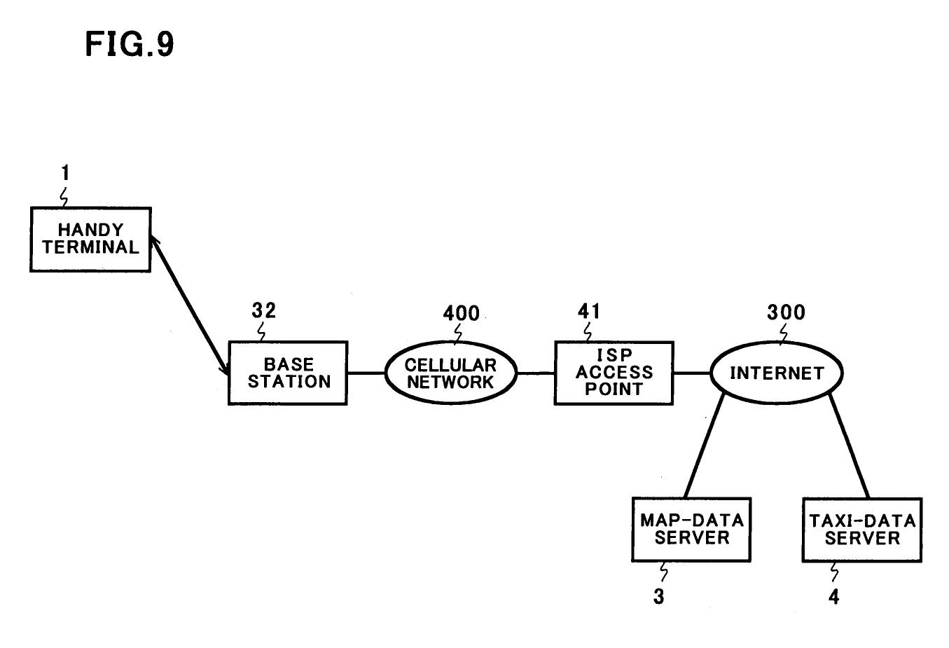

FIG. 9 illustrates a relation between the handy terminal 1 and a network in the third embodiment.

As illustrated in FIG. 9, the handy terminal 1 is designed to make access to the map-data server 3 and the taxi-data server 4 through the base station 32, a cellular network 400, an internet service provider (IPS) access point 41, and Internet 300.

An operation of the system in accordance with the third embodiment is identical with the operation of the system in accordance with the first embodiment.

In accordance with the third embodiment, the handy terminal 1 can obtain map data and taxi driver information at real-time.

[Fourth Embodiment]

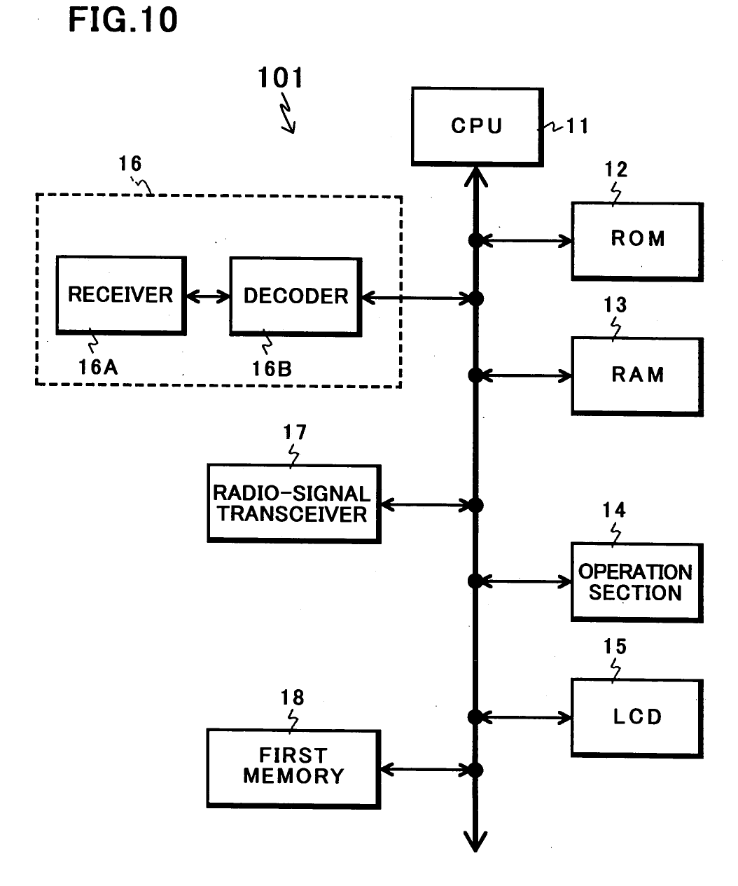

FIG. 10 is a block diagram of a handy terminal used in a system for hiring a taxi, in accordance with the fourth embodiment of the present invention.

The handy terminal 101 in the fourth embodiment is designed to additionally include a first memory 18 in comparison with the handy terminal 1 used in the first embodiment. Parts or elements that correspond to those of the handy terminal 1 in the first embodiment have been provided with the same reference numeral, and operate in the same manner as corresponding parts or elements in the handy terminal 1, unless explicitly explained hereinbelow.

The first memory 18 stores data relating to taxis which the user 1A used to hire. Based on data stored in the first memory 18, the central processing unit 11 receives data indicative of a current position of a taxi which the user 1A used to hire, from the taxi-data server 4 through the radio-signal transceiver 17.

Then, the central processing unit 11 makes access to the map-data server 3 to receive data of a map covering an area between a current position of the user 1A and a current position of the taxi 2 and data about speed restriction in the area from the map-data server 3. Based on the data received from the map-data server 3, the central processing unit 11 searches a route and calculates a distance between a current position of the user 1A and a current position of the taxi 2.

Then, the central processing unit 11 calculates an arrival time at which the taxi 2 is expected to arrive at the user 1A, based on the distance and the speed restriction, and displays the thus calculated arrival time in the liquid crystal display 15.

An operation of the system in accordance with the fourth embodiment is identical with the operation of the system in accordance with the first embodiment.

In accordance with the fourth embodiment, the user 1A can find a taxi which the user 1A used to hire and found it of good service, and hire the taxi again.

[Fifth Embodiment]

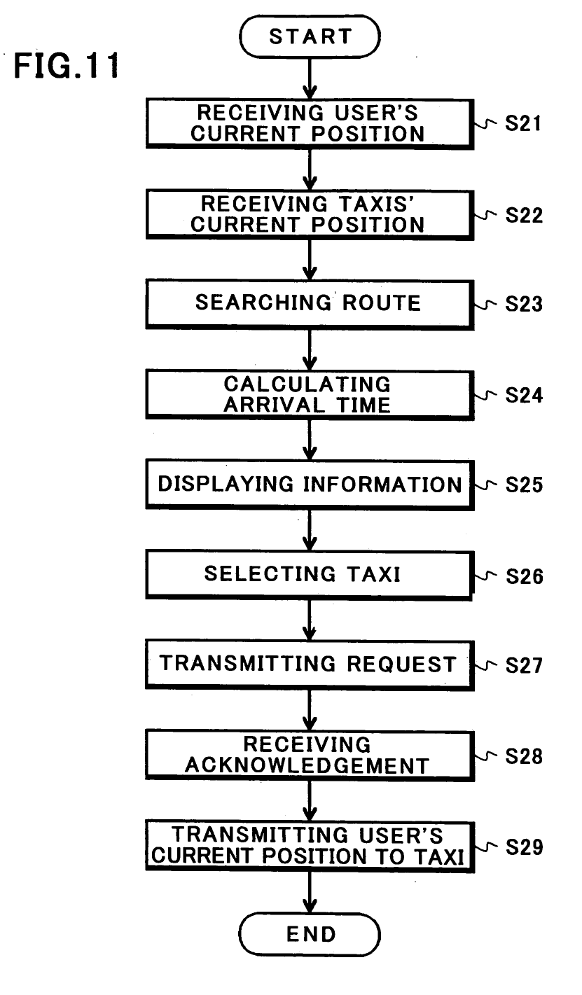

FIG. 11 is a flow-chart of an operation of a system for hiring a taxi, in accordance with the fifth embodiment.

The system in accordance with the fifth embodiment has the same structure as that of the system in accordance with the first embodiment, and a handy terminal used in the fifth embodiment has the same structure as that of the handy terminal 1 used in the first embodiment.

The system in accordance with the fifth embodiment carries out an additional step of transmitting data about a current position of the user 1A to a selected taxi at real-time, in comparison with the first embodiment.

Hereinbelow is explained an operation of the system in accordance with the fifth embodiment with reference to FIGS. 1, 2 and 11. Steps S21 to S28 in FIG. 11 are identical with steps S1 to S8 in FIG. 6, and hence, are not explained.

The central processing unit 11 transmits a request to the taxi 2 selected by the user 1A to come to the user 1A, and receives acceptance of the request from the taxi 2. Then, the central processing unit 11 transmits a current position of the user 1A to the selected taxi 2 through Internet 300 such that the selected taxi 2 can know a current position of the user 1A at real-time, in step S29.

In accordance with the fifth embodiment, it is not necessary for the user 1A to stay there to wait for the taxi 2. The user 1A may move to any place while waiting for the taxi 2.

[Sixth Embodiment]

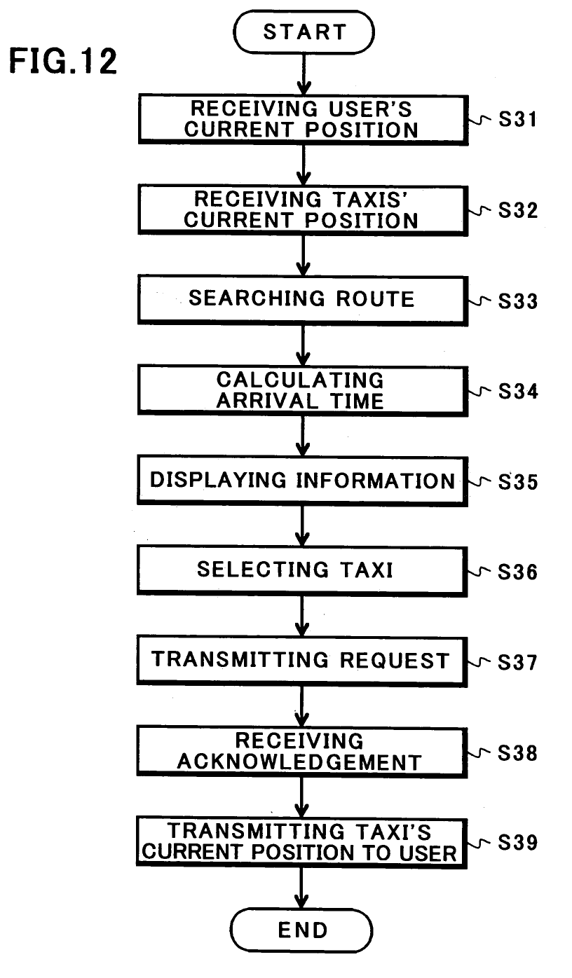

FIG. 12 is a flow-chart of an operation of a system for hiring a taxi, in accordance with the sixth embodiment.

The system in accordance with the sixth embodiment has the same structure as that of the system in accordance with the first embodiment, and a handy terminal used in the sixth embodiment has the same structure as that of the handy terminal 1 used in the first embodiment.

The system in accordance with the sixth embodiment carries out an additional step of transmitting data about a current position of a selected taxi 2 to the handy terminal 1 at real-time, in comparison with the first embodiment.

Hereinbelow is explained an operation of the system in accordance with the sixth embodiment with reference to FIGS. 1, 2 and 12. Steps S31 to S38 in FIG. 12 are identical with steps S1 to S8 in FIG. 6, and hence, are not explained.

The central processing unit 11 transmits a request to the taxi 2 selected by the user 1A to come to the user 1A, and receives acceptance of the request from the taxi 2. Then, the central processing unit 11 receives data indicative of a current position of the selected taxi 2, from the taxi-data server 4 through the radio-signal transceiver, in step S39.

In accordance with the sixth embodiment, the user 1A is kept informed of a current position of the selected taxi 2 at real-time.

[Seventh Embodiment]

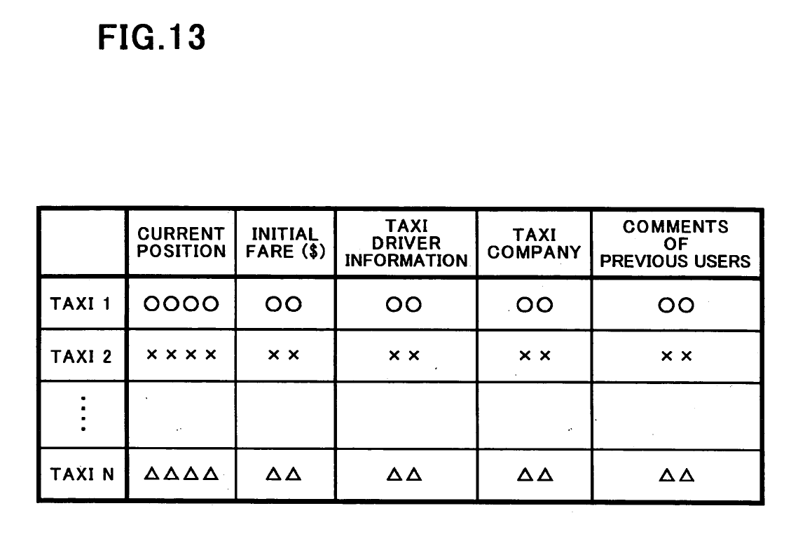

FIG. 13 illustrates a database of a taxi-data server used in a system for hiring a taxi, in accordance with the seventh embodiment.

The system in accordance with the seventh embodiment has the same structure as that of the system in accordance with the first embodiment, and a handy terminal used in the seventh embodiment has the same structure as that of the handy terminal 1 used in the first embodiment.

The taxi-data server 4 in the seventh embodiment is designed to store comments of users who used to hire each of taxis.

As illustrated in FIG. 13, the taxi-data server 4 stores a current position, an initial fare, comment of a taxi driver, a name of a taxi company, and comments of previous users, for each of the taxis 2.

The taxi-data server 4 is designed for a user who used to hire each of the taxis 2 to be able to write comments thereinto through the Internet 300. For instance, a user make comments by actuating keys arranged in the operation section 14 of the handy terminal 1, and transmits the comments to the taxi-data server 4 through the radio-signal transceiver 17, the base station .32, the packet network 200, the packet network gateway 33 and Internet 300. A user can update his/her comments stored in the taxi-data server 4 by overwriting them.

In accordance with the seventh embodiment, the user 1A can get detailed information about taxi drivers, and hence, can select only good drivers.

[Eighth Embodiment]

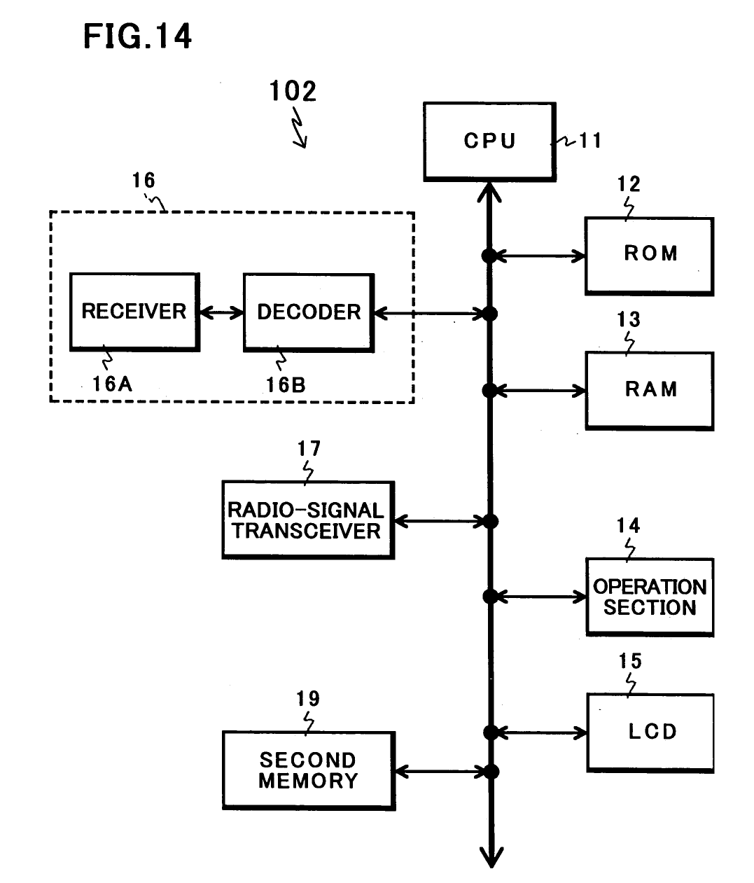

FIG. 14 is a block diagram of a handy terminal used in a system for hiring a taxi, in accordance with the eighth embodiment of the present invention.

The handy terminal 102 in the eighth embodiment is designed to additionally include a second memory 19 in comparison with the handy terminal 1 used in the first embodiment. Parts or elements that correspond to those of the handy terminal 1 in the first embodiment have been provided with the same reference numeral, and operate in the same manner as corresponding parts or elements in the handy terminal 1, unless explicitly explained hereinbelow.

The second memory 19 stores data relating to previous destinations having been input by the user 1A through the operation section 14. The central processing unit 11 transmits destination data stored in the second memory 19, to the selected taxi 2 through the radio-signal transceiver 17.

FIG. 15 is a flow-chart of an operation of the system in accordance with the eighth embodiment.

The system in accordance with the eighth embodiment has the same structure as that of the system in accordance with the first embodiment.

The system in accordance with the eighth embodiment carries out an additional step of transmitting data indicative of a destination of the user 1A, to a selected taxi 2, in comparison with the first embodiment.

Hereinbelow is explained an operation of the system in accordance with the eighth embodiment with reference to FIGS. 1, 14 and 15. Steps S41 to S46 in FIG. 15 are identical with steps S1 to S6 in FIG. 6, and hence, are not explained.

After selecting a taxi among a plurality of taxis, the central processing unit 11 transmits data indicative of a destination designated by the user 1A through the operation section 14, and data relating to previous destinations stored in the second memory 19 as well as a request to come to the user 1A and data indicative a current position of the user 1A, to the selected taxi 2 through the radio-signal transceiver 17, the base station 32, the packet network 200, the packet network gateway 33 and the Internet 300, in step S47.

Then, the central processing unit 11 receives acceptance of the request from the selected taxi 2, in step S48.

In accordance with the eighth embodiment, the user 1A can arrive at his/her destination without indicating a destination and/or a route to a taxi driver. Hence, even if the user 1A falls asleep in a taxi, he/she can surely arrive at the destination.

[Ninth Embodiment]

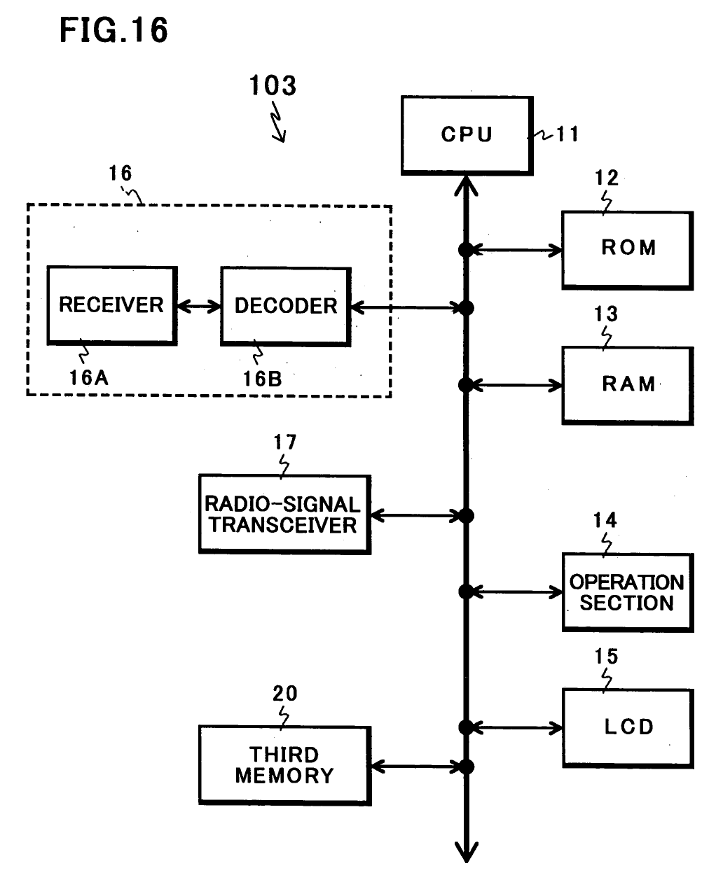

FIG. 16 is a block diagram of a handy terminal used in a system for hiring a taxi, in accordance with the ninth embodiment of the present invention.

The handy terminal 103 used in the ninth embodiment is designed to additionally include a third memory 20 in comparison with the handy terminal 1 used in the first embodiment. Parts or elements that correspond to those of the handy terminal 1 in the first embodiment have been provided with the same reference numeral, and operate in the same manner as corresponding parts or elements in the handy terminal 1, unless explicitly explained hereinbelow.

The third memory 20 stores data relating to routes of taxis which the user 1A used to hire.

The third memory 20 stores therein data relating to a route of a taxi, transmitted from the data processor 16. The central processing unit 11 reads such data out of the third memory 20, and displays the read-out data in the liquid crystal display 15.

The system in accordance with the ninth embodiment operates in the same way as the system in accordance with the first embodiment.

In accordance with the ninth embodiment, the user 1A can check whether a taxi driver selects a shortest route, and if a taxi driver does not select a shortest route, the user 1A can request a taxi driver to pay an additional charge back to the user 1A.

The system in accordance with the present invention has such a structure as mentioned above, and operates in such a manner as mentioned above.

The system may be accomplished by a data processor such as a personal computer or a work station, and a program to carry out steps to be carried out by the system in accordance with the present invention.

Such a program may be presented through a recording medium readable by a computer. The program is read out into a data processor when the data processor starts its operation. By controlling an operation of the data processor, the parts constituting the system, such as the map-data server 3, the taxi-data server 4 and the handy terminal 1, can be accomplished in the data processor. The first to third memories 18 to 20 can be accomplished by a storage device of the data processor, such as a magnetic disc.

An operation of the map-data server 3, the taxi-data server 4 and the handy terminal 1 can be accomplished by a computer program written in a language readable by a computer.

For operating the map-data server 3, the taxi-data server 4 and the handy terminal 1 by means of a computer program, they are designed to include a memory to store a computer program therein, for instance. The computer program is stored in the memory, and is read out into a central processing unit such as the central processing unit 11. Thus, such an operation of the central processing unit 11 as mentioned above is accomplished in accordance with the computer program.

As an alternative, a recording medium storing such a computer program as mentioned above may be set into the central processing unit.

The functions of the central processing unit may be accomplished as a program including various commands, and be presented through a recording medium readable by a computer.

In the specification, the term “recording medium” means any medium which can record data therein. The term “recording medium” includes, for instance, a disk-shaped recorder such as CD-ROM (Compact Disk-ROM) or PD, a magnetic tape, MO (Magneto Optical Disk), DVD-ROM (Digital Video Disk-Read Only Memory), DVD-RAM (Digital Video Disk-Random Access Memory), a floppy disk, a memory chip such as RAM (Random Access Memory) or ROM (Read Only Memory), EPROM (Erasable Programmable Read Only Memory), EEPROM (Electrically Erasable Programmable Read Only Memory), smart media (Registered Trade Mark), a flush memory, a rewritable card-type ROM such as a compact flush card, a hard disk, and any other suitable means for storing a program therein.

A recording medium storing a program for accomplishing the above-mentioned apparatus may be accomplished by programming functions of the above-mentioned apparatuses with a programming language readable by a computer, and recording the program in a recording medium such as mentioned above.

A hard disc equipped in a server may be employed as a recording medium. It is also possible to accomplish the recording medium in accordance with the present invention by storing the above-mentioned computer program in such a recording medium as mentioned above, and reading the computer program by other computers through a network.

As a computer, there may be used a personal computer, a desk-top type computer, a note-book type computer, a mobile computer, a lap-top type computer, a pocket computer, a server computer, a client computer, a workstation, a host computer, a commercially available computer, and electronic exchanger, for instance.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2002-321935 filed on Nov. 6, 2002 including specification, claims, drawings and summary is incorporated herein by reference in its entirety.

What is claimed is:

1. A system for hiring a taxi, comprising a handy terminal, a receiver equipped in a taxi, and a calculator,
said handy terminal having functions of detecting a current position of itself through GPS (Global Positioning System), and transmitting a request to said receiver of a taxi located in the vicinity of said handy terminal that said taxi comes to said handy terminal,
said calculator calculating an arrival time at which said taxi is expected to arrive at said handy terminal, based on said current position of said handy terminal and a current position of said taxi.

2. The system as set forth in claim 1, wherein said calculator is equipped in said handy terminal.

3. The system as set forth in claim 1, further comprising a taxi-data server storing therein data relating to said taxi,
said handy terminal having a function of displaying said taxi data transmitted from said taxi-data server.

4. The system as set forth in claim 3, wherein said taxi data includes at least one of a current position of said taxi, a fare of said taxi, an age of a driver of said taxi, years for which a driver of said taxi continues service, comments of said driver, and comments of a user who previously took said taxi.

5. The system as set forth in claim 3, wherein said handy terminal displays a plurality of said taxi data therein such that a user of said handy terminal can select a taxi among displayed taxis, based on said plurality of said taxi data.

6. The system as set forth in claim 3, wherein said handy terminal downloads said taxi data from said taxi-data server thereto through a packet network, a packet network gateway and Internet.

7. The system as set forth in claim 3, wherein said handy terminal downloads said taxi data from said taxi-data server thereto through a cellular phone network, an access point of an Internet service provider (ISP) and Internet.

8. The system as set forth in claim 3, further comprising a memory storing data of taxis which users used to hire, and wherein said calculator receives a current position of a taxi which a user of the handy terminal selects among said taxis, from said taxi-data server, and calculates an arrival time at which said selected taxi is expected to arrive at said handy terminal, based on a current position of said handy terminal and said current position of said taxi.

9. The system as set forth in claim 1, wherein said handy terminal receives, after transmission of said request to said receiver, at least one of a current position of said handy terminal and a current position of said taxi at real-time.

10. The system as set forth in claim 4, wherein said taxi-data server receives comments of a user of said handy terminal about a taxi which said user hired, through Internet.

11. The system as set forth in claim 1, wherein said handy terminal includes a transmitter transmitting data of a destination to said receiver when said handy terminal transmits said request to said receiver.

12. The system as set forth in claim 1, wherein said handy terminal includes a memory storing therein data of a route which a taxi a user of said handy terminal hired ran.

13. The system as set forth in claim 1, wherein said handy terminal is comprised of a cellular phone.

14. The system as set forth in claim 1, further comprising a map-data server storing therein data about a map of an area covering from a current position of said taxi to a current position of said handy terminal, and data about speed restriction of roads in said area,
said handy terminal receiving said data from said map-data server.

15. A handy terminal used in a system for hiring a taxi, said system being comprised of said handy terminal and a receiver equipped in a taxi,
said handy terminal having functions of detecting a current position of itself through GPS (Global Positioning System), and transmitting a request to said receiver equipped in a taxi located in the vicinity of said handy terminal that said taxi comes to said handy terminal,
said handy terminal including a calculator calculating an arrival time at which said taxi is expected to arrive at said handy terminal, based on said current position of said handy terminal and a current position of said taxi.

16. The handy terminal as set forth in claim 15, wherein said system further includes a taxi-data server storing therein data relating to said taxi, and wherein said handy terminal has a function of displaying said taxi data transmitted from said taxi-data server.

17. The handy terminal as set forth in claim 16, wherein said handy terminal displays a plurality of said taxi data such that a user of said handy terminal can select a taxi among displayed taxis, based on said plurality of said taxi data.

18. The handy terminal as set forth in claim 16, wherein said handy terminal downloads said taxi data from said taxi-data server thereto through a packet network, a packet network gateway and Internet.

19. The handy terminal as set forth in claim 16, wherein said handy terminal downloads said taxi data from said taxi-data server thereto through a cellular phone network, an access point of an Internet service provider (ISP) and Internet.

20. The handy terminal as set forth in claim 16, further comprising a memory storing data of taxis which other users used to hire, said calculator receiving a current position of a taxi which a user of the handy terminal selects among said taxis, from said taxi-data server, and calculating an arrival time at which said selected taxi is expected to arrive at said handy terminal, based on a current position of said handy terminal and said current position of said taxi.

21. The handy terminal as set forth in claim 15, wherein said handy terminal receives, after transmission of said request to said receiver, at least one of a current position of said handy terminal and a current position of said taxi at real-time.

22. The handy terminal as set forth in claim 15, further including a transmitter transmitting data of a destination to said receiver when said handy terminal transmits said request to said receiver.

23. The handy terminal as set forth in claim 15, further including a memory storing therein data of a route which a taxi a user of said handy terminal hired ran.

24. The handy terminal as set forth in claim 15, wherein said handy terminal is comprised of a cellular phone.

25. A method of hiring a taxi by transmitting a request from a user's handy terminal to a receiver equipped in a taxi located in the vicinity of said handy terminal that said taxi comes to said handy terminal, comprising:
(a) detecting a current position of said handy terminal through GPS (Global Positioning System); and
(b) calculating an arrival time at which said taxi is expected to arrive at said handy terminal, based on said current position of said handy terminal and a current position of said taxi.

26. The method as set forth in claim 25, further comprising:
(c) receiving data relating to said taxi from a taxi-data server; and
(d) displaying said taxi data in said handy terminal.

27. The method as set forth in claim 26, wherein said handy terminal displays a plurality of said taxi data in said (d) such that a user of said handy terminal can select a taxi among displayed taxis, based on said plurality of said taxi data.

28. The method as set forth in claim 26, further comprising downloading said taxi data from said taxi-data server to said handy terminal through a packet network, a packet network gateway and Internet.

29. The method as set forth in claim 26, further comprising downloading said taxi data from said taxi-data server to said handy terminal through a cellular phone network, an access point of an Internet service provider (ISP) and Internet.

30. The method as set forth in claim 26, further comprising;
storing data of taxis which users used to hire; and
receiving a current position of a taxi which a user of the handy terminal selects among said taxis, from said taxi-data server.

31. The method as set forth in claim 26, further comprising transmitting comments of a user of said handy terminal about a taxi which said user hired, to said taxi-data server through Internet.

32. The method as set forth in claim 25, further comprising transmitting data of a destination to said receiver when said handy terminal transmits said request to said receiver.

33. The method as set forth in claim 25, further comprising storing therein data of a route which a taxi a user of said handy terminal hired ran.

34. A program for causing a computer to carry out a method of hiring a taxi by transmitting a request from a user's handy terminal to a receiver equipped in a taxi located in the vicinity of said handy terminal that said taxi comes to said handy terminal, and wherein steps executed by said computer in accordance with said program include:
(a) detecting a current position of said handy terminal through GPS (Global Positioning System); and
(b) calculating an arrival time at which said taxi is expected to arrive at said handy terminal, based on said current position of said handy terminal and a current position of said taxi.

35. The program as set forth in claim 34, wherein said steps further include:
(c) receiving data relating to said taxi from a taxi-data server; and
(d) displaying said taxi data in said handy terminal.

36. The program as set forth in claim 34, wherein a plurality of said taxi data is displayed in said (d) such that a user of said handy terminal can select a taxi among displayed taxis, based on said plurality of said taxi data.

37. The program as set forth in claim 34, wherein said steps further include downloading said taxi data from said taxi-data server to said handy terminal through a packet network, a packet network gateway and Internet.

38. The program as set forth in claim 34, wherein said steps further include downloading said taxi data from said taxi-data server to said handy terminal through a cellular phone network, an access point of an Internet service provider (ISP) and Internet.

39. The program as set forth in claim 34, wherein said steps further include:
storing data of taxis which users used to hire; and
receiving a current position of a taxi which a user of the handy terminal selects among said taxis, from said taxi-data server.

40. The program as set forth in claim 35, wherein said steps further include transmitting comments of a user of said handy terminal about a taxi which said user hired, to said taxi-data server through Internet.

41. The program as set forth in claim 34, wherein said steps further include transmitting data of a destination to said receiver when said handy terminal transmits said request to said receiver.

42. The program as set forth in claim 34, wherein said steps further include storing therein data of a route which a taxi a user of said handy terminal hired ran.
